(19) United States
(12) Patent Application Publication
(10) Pub. No.: US 2021/0319401 A1
(43) Pub. Date: Oct. 14, 2021

(54) "GOFOR" FINAL MILE PACKAGE PICKUP

(71) Applicant: Atlantic HR Solutions Inc., Murrells Inlet, SC (US)

(72) Inventor: Keith Carter, Murrells Inlet, SC (US)

(21) Appl. No.: 17/223,467

(22) Filed: Apr. 6, 2021

Related U.S. Application Data
(60) Provisional application No. 63/008,907, filed on Apr. 13, 2020.

(51) Int. Cl. G06Q 10/08; G06Q 50/30; G06K 7/14

(52) U.S. Cl. CPC G06Q 10/08355; G06K 7/1417; G06Q 50/30; G06Q 10/0833

(57) ABSTRACT

A final mile delivery system is disclosed and provides for delivering a package to a customer within a final mile. The system is configured to send information relating to a location of a delivery truck to a customer associated with a package on the delivery truck and send an authorization code to the customer that associates the customer with the package on the delivery truck. The customer may than go to the delivery truck where the package is released to the customer at an alternate delivery location that is not an original package destination in response to the operator of the delivery truck acknowledging the authorization code in possession of the customer.

### CROSS REFERENCE TO RELATED APPLICATION

This application claims priority to U.S. Provisional Application No. 63/008,907 filed on Apr. 13, 2020.

### TECHNICAL FIELD

The present disclosure relates to method and system for facilitating package pickup by a customer during the last stage of delivery known as the “final mile.”

### BACKGROUND

The “final mile” is a term utilized in the shipping industry to describe the period of time when a package on the last truck that will deliver the package to the customer. As appreciated, a package may proceed through different processing centers and shipping vehicles prior to being delivered to a customer's doorstep. All aspects of the shipping process can be tracked with an acceptable degree of detail. However, the “final mile” is typically only communicated to a customer as “out on truck for delivery.”

The “final mile” is the most inefficient time during the delivery process as the delivery truck must typically stop at one location for each package. Other parts of the delivery process include many packages moving between processing centers and is much more efficient. Shipping and delivery companies continually seek systems and methods to improve efficiency, reduce costs and improve the customer experience.

### SUMMARY

A method for delivering a package to a customer according to one disclosed example embodiment includes, among other possible things, sending information relating to a location of a delivery truck to a customer associated with a package on the delivery truck, sending an authorization code to the customer that associates the customer with the package on the delivery truck, and releasing the package to the customer at an alternate delivery location that is not an original package destination in response to the operator of the delivery truck acknowledging the authorization code in possession of the customer.

A further example embodiment of the foregoing methods includes providing a communication link between the customer and an operator of the delivery truck.

In a further example embodiment of any of the foregoing methods the original package destination comprises an address provided upon ordering of the package and the alternate delivery location is one determined by the operator of the delivery truck and the customer.

In a further example embodiment of any of the foregoing methods, the alternate destination comprises a preset location not associated with the customer.

In a further example embodiment of any of the foregoing methods, the location of the delivery truck sent to the customer is within a delivery route between a processing center and the original package destination.

In a further example embodiment of any of the foregoing methods, the location of the delivery truck is obtained from a GPS system.

In a further example embodiment of any of the foregoing methods, the authorization code comprises an electronically transmitted code that is transmitted to a communication device associated with the customer.

In a further example embodiment of any of the foregoing methods, the communication device comprises a cellular phone.

In a further example embodiment of any of the foregoing methods, the authorization code comprises one of three-dimensional or a two-dimensional bar code viewable as an image on the communication device.

In a further example embodiment of any of the foregoing methods, the authorization code comprises an alphanumeric string.

A further example embodiment of any of the foregoing methods includes sending the authorization code to the customer in response to a request by the customer.

In a further example embodiment of any of the foregoing methods, the communication link comprises a contact number for contacting a communication device associated with the operator of the delivery truck.

A system for delivering a package to a customer according to another disclosed example embodiment includes, among other possible things, a communication link configured to send information relating to a location of a delivery truck to a customer associated with a package on the delivery truck, a controller configured to assign and send an authorization code to the customer that associates the customer with the package on the delivery truck, a mobile communication device configured to recognize the authorization code sent to the customer and provide information to an operator of the delivery truck utilized to authorize release of the package to the customer at an alternate delivery location that is not an original package destination.

In another example embodiment of the foregoing system, the communication link is further configured to send information to the customer that provides for establishment of communication between the customer and an operator of the delivery truck.

In another example embodiment of any of the foregoing systems, the original package destination comprises an address provided upon ordering of the package and the alternate delivery location is one determined by the operator of the delivery truck and the customer.

In another example embodiment of any of the foregoing systems, the alternate delivery location is a preset location that is not associated with the customer.

In another example embodiment of any of the foregoing systems, the location of the delivery truck sent to the customer is within a delivery route between a processing center and the original package destination.

In another example embodiment of any of the foregoing systems, the authorization code comprises an electronically transmitted code that is transmitted to a communication device associated with the customer.

A non-transitory tangible computer readable medium including a set of computer executable instructions for communicating with a customer and delivering a package according to another disclosed example embodiment where the computer executable instructions provide for establishing a communication link between a delivery service and a communication device associated with a customer to enable receipt of information relating to a location of a delivery truck to the customer associated with a package on the delivery truck, receiving an authorization code generated by the delivery service associated with the customer and the package, communicating an alternate delivery location to an operator of the delivery truck including the package, and communicating the received authorization code to a mobile computing device operated by the operator of the delivery truck to establish authorization to receive the package at the alternate delivery location.

In another example embodiment of the forgoing computer executable instructions, the instructions further provide for establishment of a communication link between the communication device associated with the customer and the mobile computing device operated by the operator.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of the final mile of delivery of a package to a customer.

FIG. 2 is a schematic view of an example final mile package delivery system.

FIG. 3 is a flow diagram of example steps for delivery of a package with the example final mile package delivery system.

### DETAILED DESCRIPTION

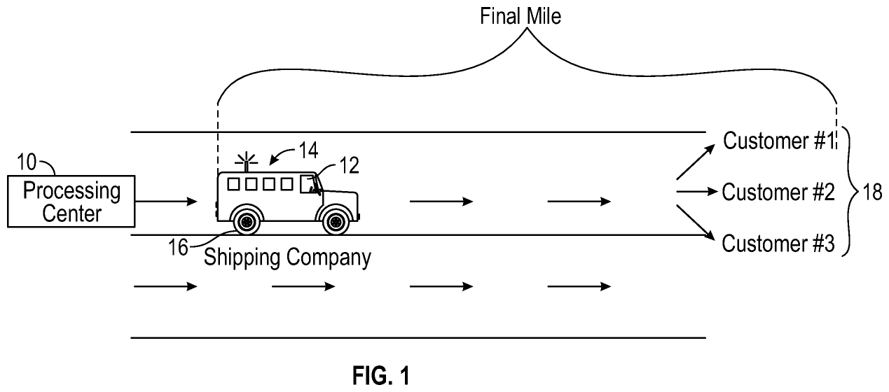

Referring to the FIG. 1, the “final mile” of package delivery is performed by a delivery truck 12 that picks up packages 16 from a local processing center 10. The delivery truck 12 delivers each of the many packages to customers 18. The customers 18 are all in different places and so the delivery truck 12 must go to a different place for each of the packages 16. Even with careful planning of an efficient route for the delivery truck 12, final mile deliveries are the least efficient portion of any package delivery. Moreover, even though one customer 18 may receive more than one package, the delivery truck 12 is required to make many different and individual stops along the delivery route.

Customers 18 may be able to track the packages 16 to the processing center 10 to have a good understanding of when a package will arrive. However, once the package is loaded on the delivery truck 12, the only information that the customer 18 is provided is that the package is out on the truck for delivery. In instances where receipt of a package is critical to business operation or for coordinating activities, communication that is more precise with regard to the location and delivery time of the package is desirable.

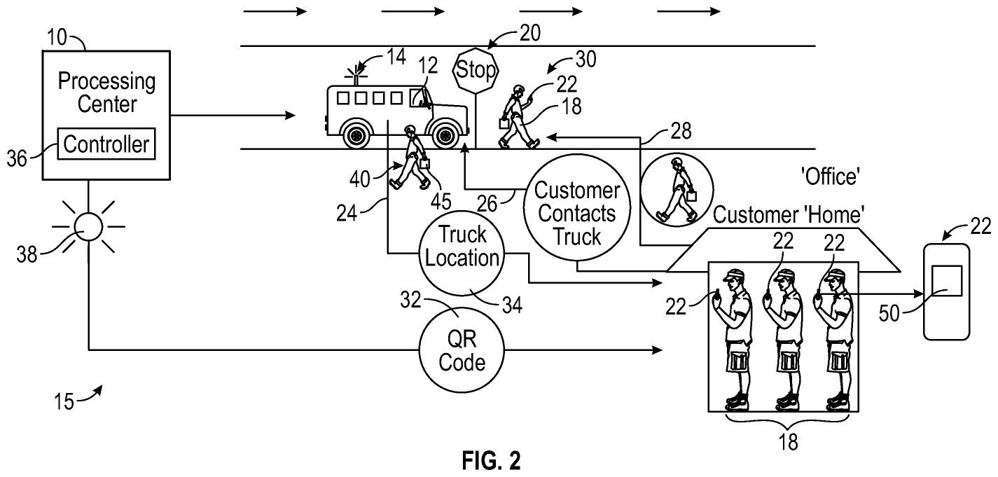

Referring to FIG. 2, a disclosed final mile delivery system 15 for improving efficiency of final mile deliveries is schematically shown. The delivery system 15 provides for tracking and communication between a customer 18 and a delivery truck operator 40 to coordinate delivery of a package 16 at an alternate location. In this disclosed example, the alternate location is some location other than an original location specified at the time the package was ordered. The alternate location is somewhere along the route of the delivery truck 12 between the processing center 10 and the final destination of the package.

The disclosed delivery system 15 thereby provides a means for a customer 18 to track and pick up important and time sensitive packages rather than wait for that final mile of delivery.

The disclosed example system 15 includes a controller 36 located at a remote location that is in communication with communication link 38. In this example, the remote location corresponds with the processing center 10. The controller 36 may be part of the delivery service and may be located at a central location.

The disclosed controller 36 may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

The controller 36 is configured to execute software stored within the memory, to communicate data to and from the memory, and to generally control operations of the computing device pursuant to the software. Software in memory, in whole or in part, is read by the processor, perhaps buffered within the processor, and then executed.

In this example, the controller 36 is coupled to a communication link 38 that provides for communication with a computing device associated with a customer 18. In one example embodiment, the computing device comprises a mobile computing device 22 linked through a wireless and/or cellular network to the controller 36. The processing center 10 includes information associating the customer 18 with a specific package 16. The customer 18 is provided access through the communication link 38 to a location of the delivery truck 12.

The access provided the customer 18 is through the mobile computing device 22. In this example system, a program commonly referred to as an application 50 is provided to the mobile phone 22 associated with the customer 18. The application 50 provides a set of instructions that are executable by the mobile phone 22 that provides for establishment of a communication link between the delivery service to provide for transmission and receipt of a location of the delivery truck 12. The instructions are stored on a tangible, non-transitory medium within the mobile phone 22. Moreover, the instructions defining the application 50 may also be stored within a tangible, non-transitory storage medium of the controller 36 for distribution to remotely located computing devices such as the customer associated cell phone 22. It should be understood, that the term non-transitory as used in this disclosure is a limitation of the medium itself rather than a limitation on data storage persistency.

In one example, the communication link is established by a recognition of the customer 18 based on information provided with the order of the package 16. Such information can include customer specific information, such as an address, combined with package specific information.

The application 50 further provides for the receipt and storage of an authorization code 32 generated by the controller 36 that associates the customer 18 with the package 16. The authorization code 32 is a code that confirms identification of the customer 18 with respect to a package 16. In one disclosed example, the authorization code is a bar code, or QR code 32 that can be displayed on the mobile phone 22 through the application 50. It should be appreciated that other types of code could also be utilized within the scope and contemplation of this disclosure.

The application 50 further includes instructions that provide for communication with the operator 40 of the delivery truck 12 an alternate delivery location. The instructions may include contact information, communication codes along with any other means of establishing communication between the customer 18 and the operator 40. The application 50 may also include an operator 40 version that provides for the operator 40 to confirm the authorization code 32 presented by the customer 18.

The system 15 utilized the application 50 to gather information and communicate that information to the customer 18 in a way that enables a customer to coordinate a pickup of a package directly with the operator 40 of the delivery truck 12. The customer 18 utilizes the application 50 and cellular phone 22 to receive information that enables communication with the operator 40 of the delivery truck 12 to coordinate pickup of the package 16. As appreciated, although the disclosed example uses an application 50 on a cellular phone 22, other mobile computing devices could be utilized and are within the contemplation of this disclosure.

Delivery trucks 12 are already equipped with global positioning systems (GPS) 14 that communicate the location of the truck to the shipping company. Moreover, the truck uses the GPS 14 to determine an efficient route for delivery of the packages to the customers.

The system 15 uses the example communication link 38 to provide for messages, texting and location information to be sent to individual customers. In this example system, the application 50 will gather information and communicate that information in a way that enables the customer 18 to coordinate a pickup of the package 16 directly with the operator 40 of the delivery truck 12. The customer 18 will download the application 50 for use on a cellular phone 22 to receive this information and communicate with the operator of the delivery truck 12. As appreciated, although the disclosed example uses an application 50 on a cellular phone 22, other mobile computing devices could be utilized and are within the contemplation of this disclosure. Moreover, other computing and/or communication devices could be utilized within the contemplation and scope of this disclosure.

The application 50 on the customer's cellular phone 22 communicates with the processing center 10 and the delivery truck 12. The location of the delivery truck 12 is provided by the GPS 14 to the processing center 10 and to the customer 18, either directly and/or through the communication link 38 with the processing center 10. The application 50 loaded on the cellular phone 22 includes security features to assure that information regarding the package is only available to the customer 18 that ordered the package and/or some authorized representative. The processing center 10 may be local and/or a centrally located processing center that initiates a link that enables communication between the customer 18 and the delivery truck 12.

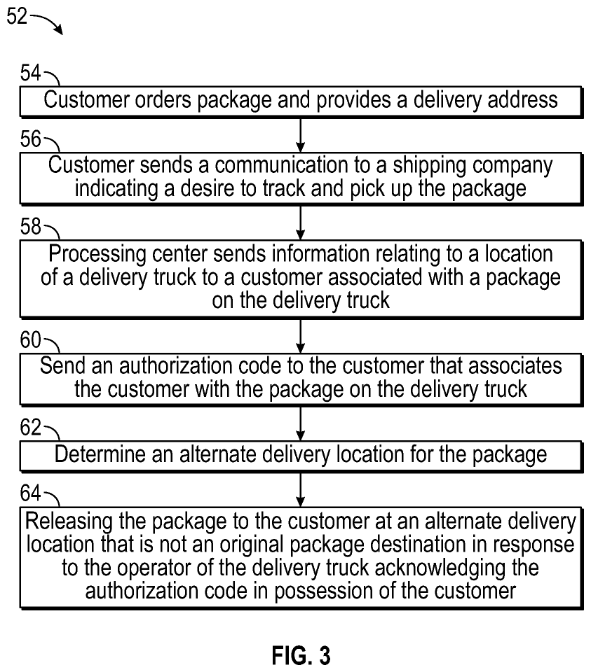

Referring to FIG. 3 with continued reference to FIG. 2, a flow diagram of an example disclosed embodiment is shown at 52. At the time a package is ordered, a customer provides a delivery address as is shown at 54. The example system operates by enabling a customer 18 to request a location of the delivery truck 12 in order to enable the customer 18 to “gofor” the package rather than wait for the delivery truck 12 to deliver to the original destination, such as the customer's home or office. A customer 18 would indicated the desire to pick-up or intercept a package 16 prior to delivery to the original destination as is indicated at 56. The customer 18 would indicate this interest through communication with the processing center 10 by way of the communication link 38. The customer 18 may also download the application 50 for the specific delivery service for this communication.

The processing center 10, by way of the controller 36 will authenticate the customer request and association with the package and provide information about the location of the delivery truck 12 to the customer as indicated at 58. The customer may than determine if they desired to intercept the truck to pick-up the package or wait for delivery. If the customer 18 desired to pick-up the package prior to delivery to the original location, the customer 18 can request an authorization code 32. The processing center 10 or originator of the package will send the code 32, indicated at 60, to the customer 18 to associate the customer 18 with a package 16 on the delivery truck 12. In this example, the code 32 is in the form of a QR code messaged to the customer's phone 12. The code 32, could be an alphanumeric code 32, bar code or any other known code format. The code 32 enables the operator 40 of the delivery truck 12 to confirm that a package belongs to the customer 18. The operator 40 will include a mobile communication device 45 that provides for reading of the code 32. The device 45 may include other features utilized by the operator 40 to read other information relating to the shipment of the packages 16.

Along with issuing of the code 32, the processing center 10 and/or shipping company may also provide a communication link with the operator 40 of the delivery truck 12. In one example embodiment, the ability of the customer 18 to track the location of the delivery truck 12 is enabled through the application 50 present on the customer's phone 22. Moreover, the ability of the customer 18 to track the delivery truck 12 can be coordinated in a manner that requires verification and provided for a limited time to prevent unauthorized tracking of the delivery truck 12.

Once the customer 18 has been authorized to track the delivery truck 12, the customer 18 will be able to receive information as to the location of the delivery truck 12 as is indicated at 34 (FIG. 2). The location 34 of the delivery truck 12 can be provided within the application 50 on the customer's phone 22. The customer 18 may then communicate directly with the operator 40 of the delivery truck 12 to coordinate pick up of the package 16 at an alternate location schematically shown at 26 in FIG. 2 and as indicated at 62 in FIG. 3. The customer 18 then goes to the location of the delivery truck 12 as indicated at 28 in FIG. 2. The customer 18 provides the issued code 32 and the delivery truck operator 40 confirms the validity of the code 32 and give the package 16 to the customer 18 as schematically shown at 28 in FIG. 2 and indicated at 64 in FIG. 3. The delivery truck 12 can then continue other deliveries with one less package to deliver.

Accordingly, one example sequence of package delivery according to an example disclosed embodiment begins with a customer downloading a software application 50 onto their phone 22. The application 50 enables the customer 18 to communicate with a shipping company regarding a package. Once the shipping company verifies the customer's association with a package, the shipping company issues a code 32 to the customer 18. The shipping company will also authorize communication of location information 34 for the delivery truck 12 to the customer 18. The customer 18 may then track the package on the delivery truck 12. The customer 18 can use this final mile tracking of the delivery truck 12 to obtain a more precise time of delivery.

The customer 18 is further provided authorization and the ability to communicate directly with the operator 40 of the delivery truck 12. With the ability to communicate directly with the operator 40 of the delivery truck 12, the customer 18 can go to the location of the truck 12 and pick up the package 16 directly, without waiting. The operator 40 of the delivery truck 12 uses the code 32 to establish the credentials and identity to provide a secure handing over of the package 16 to the customer 18 as indicated at 30. The shipping company is secure in the confirmation provided by the code 32 that the right customer 18 got the right package. Once confirmed and handed over, the delivery truck 12 will continue delivery with one less package to deliver.

In another example, preset locations, or “gofor holes” indicated at 20 are defined and enable a customer 18 to coordinate pick up of packages from the delivery truck 12. The preset locations 20 can be a parking lot, store front or any other convenient location for the delivery truck to briefly stop and hand out packages to customers 18. Accordingly, a customer 18 can communicate with the delivery truck 12 to understand when the truck 12 will be at the preset location 20 at pick up the package directly from the truck 12. Alternatively, the truck 12 may simply make the preset location 20 a scheduled stop on the daily delivery route and the customer 18, using the application 50, will know the location and time to expect and meet the delivery truck 12 for package pick up. The code 32 provides authorization for the customer to pick up the package. The delivery truck 12 therefore reduces the number of individual stops necessary to reduce delivery time and costs.

Accordingly, the example system enables tracking and pick up of packages within the final mile to reduce delivery time, costs and improve customer satisfaction.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A method for delivering a package to a customer comprising:
sending information relating to a location of a delivery truck to a customer associated with a package on the delivery truck;
sending an authorization code to the customer that associates the customer with the package on the delivery truck; and
releasing the package to the customer at an alternate delivery location that is not an original package destination in response to the operator of the delivery truck acknowledging the authorization code in possession of the customer.

2. The method as recited in claim 1, further comprising providing a communication link between the customer and an operator of the delivery truck.

3. The method as recited in claim 1, wherein the original package destination comprises an address provided upon ordering of the package and the alternate delivery location is one determined by the operator of the delivery truck and the customer.

4. The method as recited in claim 2, wherein the alternate location is a preset location not associated with the customer.

5. The method as recited in claim 4, wherein the location of the delivery truck sent to the customer is within a delivery route between a processing center and the original package destination.

6. The method as recited in claim 1, wherein the location of the delivery truck is obtained from a GPS system.

7. The method as recited in claim 1, wherein the authorization code comprises an electronically transmitted code that is transmitted to a communication device associated with the customer.

8. The method as recited in claim 7, wherein the communication device comprises a cellular phone.

9. The method as recited in claim 7, wherein the authorization code comprises one of three-dimensional or a two-dimensional bar code viewable as an image on the communication device.

10. The method as recited in claim 7, wherein the authorization code comprises an alphanumeric string.

11. The method as recited in claim 1, including sending the authorization code to the customer in response to a request by the customer.

12. The method as recited in claim 1, wherein the communication link comprises a contact number for contacting a communication device associated with the operator of the delivery truck.

13. A system for delivering a package to a customer, the system comprising:
a communication link configured to send information relating to a location of a delivery truck to a customer associated with a package on the delivery truck;
a controller configured to assign and send an authorization code to the customer that associates the customer with the package on the delivery truck; and
a mobile communication device configured to recognize the authorization code sent to the customer and provide information to an operator of the delivery truck utilized to authorize release of the package to the customer at an alternate delivery location that is not an original package destination.

14. The system for delivering a package as recited in claim 13, wherein the communication link is further configured to send information to the customer that provides for establishment of communication between the customer and an operator of the delivery truck.

15. The system for delivering a package as recited in claim 13, wherein the original package destination comprises an address provided upon ordering of the package and the alternate delivery location is one determined by the operator of the delivery truck and the customer.

16. The system for delivering a package as recited in claim 13, wherein the alternate delivery location is a preset location that is not associated with the customer.

17. The system for delivering a package as recited in claim 13, wherein the location of the delivery truck sent to the customer is within a delivery route between a processing center and the original package destination.

18. The system for delivering a package as recited in claim 13, wherein the authorization code comprises an electronically transmitted code that is transmitted to a communication device associated with the customer.

19. A non-transitory tangible computer readable medium including a set of computer executable instructions for communicating with a customer and delivering a package, the computer executable instructions providing for:
establishing a communication link between a delivery service and a communication device associated with a customer to enable receipt of information relating to a location of a delivery truck to the customer associated with a package on the delivery truck;
receiving an authorization code generated by the delivery service associated with the customer and the package;
communicating an alternate delivery location to an operator of the delivery truck including the package; and
communicating the received authorization code to a mobile computing device operated by the operator of the delivery truck to establish authorization to receive the package at the alternate delivery location.

20. The set of computer readable instructions recited in claim 19, further comprising instructions providing for a communication link between the communication device associated with the customer and the mobile computing device operated by the operator.
